(19) United States
(12) Patent Application Publication
(10) Pub. No.: US 2015/0242805 A1
(43) Pub. Date: Aug. 27, 2015

(54) OUT-OF-STOCK NOTIFICATION SYSTEM, OUT-OF-STOCK NOTIFICATION DEVICE, OUT-OF-STOCK NOTIFICATION METHOD, AND PROGRAM

(71) Applicant: Rakuten, Inc., Tokyo (JP)

(72) Inventor: Yusuke Sakurai, Shinagawa-ku (JP)

(21) Appl. No.: 14/421,443

(22) PCT Filed: Jul. 9, 2013
(86) PCT No.: PCT/JP2013/068722

§ 371 Date: Feb. 13, 2015

(30) Foreign Application Priority Data
Nov. 30, 2012 (JP) 2012-262269

(51) Int. Cl. G06Q 10/08; G06Q 30/00

(52) U.S. Cl. CPC G06Q 10/087; G06Q 30/00

(57) ABSTRACT

In order to reduce such a possibility that a user who has made an arrival notification request makes an access to an item page of an item out of stock, arrival notification request reception means of an out-of-stock notification system receives the arrival notification request for the item from the user. When the item becomes in stock, arrival notification means notifies an arrival notification to the user. Out-of-stock notification means notifies, when the item becomes out of stock after the arrival notification has been notified, an out-of-stock notification to the user whose arrival notification request has been received.

### TECHNICAL FIELD

The present invention relates to an out-of-stock notification system, an out-of-stock notification device, an out-of-stock notification method, and a program.

### BACKGROUND ART

Hitherto, there has been known a technology for notifying a user of the arrival of merchandise at the time the merchandise arrives . In Patent Literature 1, there is disclosed a technology for transmitting, in a system for providing an Internet shopping service, an arrival notification upon arrival of an item to a user who has requested for the arrival notification of the item.

### CITATION LIST

### Patent Literature

[PTL 1] JP 2003-30507 A

### SUMMARY OF INVENTION

### Technical Problem

In the above-mentioned technology, even if the arrival notification is notified to the user, subsequently the item can be sold out, and the item can be out of stock again. Thus, when the user sees the arrival notification and makes an access to an item page, the item may be out of stock again at the time of the access. In this case, the user makes the access to the item page in vain.

The present invention has been made in view of the above-mentioned problem, and therefore has an object to provide an out-of-stock notification system, an out-of-stock notification device, an out-of-stock notification method, and a program capable of reducing such a possibility that a user who has requested for an arrival notification makes an access to an item page of an item which is out of stock.

### Solution to Problem

In order to solve the above-mentioned problem, an out-of-stock notification system according to one embodiment of the present invention includes: means for acquiring a storage content of means for storing data on a stock of an item; arrival notification request reception means for receiving an arrival notification request for the item from a user; arrival notification means for carrying out, when the item comes in stock, an arrival notification to the user whose arrival notification request has been received; and out-of-stock notification means for carrying out, when the item becomes out of stock after the arrival notification is notified, an out-of-stock notification to the user whose arrival notification request has been received.

Further, an out-of-stock notification device according to one embodiment of the present invention includes: means for acquiring a storage content of means for storing data on a stock of an item; arrival notification request reception means for receiving an arrival notification request for the item from a user; arrival notification means for carrying out, when the item comes in stock, an arrival notification to the user whose arrival notification request has been received; and out-of-stock notification means for carrying out, when the item becomes out of stock after the arrival notification is notified, an out-of-stock notification to the user whose arrival notification request has been received.

Further, an out-of-stock notification method according to one embodiment of the present invention includes: a step of acquiring a storage content of means for storing data on a stock of an item; an arrival notification request reception step of receiving an arrival notification request for the item from a user; an arrival notification step of carrying out, when the item comes in stock, an arrival notification to the user whose arrival notification request has been received; and an out-of-stock notification step of carrying out, when the item becomes out of stock after the arrival notification is notified, an out-of-stock notification to the user whose arrival notification request has been received.

Further, a program according to one embodiment of the present invention causes a computer to function as: means for acquiring a storage content of means for storing data on a stock of an item; arrival notification request reception means for receiving an arrival notification request for the item from a user; arrival notification means for carrying out, when the item comes in stock, an arrival notification to the user whose arrival notification request has been received; and out-of-stock notification means for carrying out, when the item becomes out of stock after the arrival notification is notified, an out-of-stock notification to the user whose arrival notification request has been received.

Further, an information storage medium according to one embodiment of the present invention is a computer-readable information storage medium having the above-mentioned program recorded thereon.

Further, in one aspect of the present invention, the out-of-stock notification system further includes means for acquiring access history to an item page of the item by the user whose arrival notification request has been received, and the out-of-stock notification means notifies, when such history that the user makes an access to the item page is absent in the access history in a period from a time point when the arrival notification is notified to a time point when the item becomes out of stock, the out-of-stock notification to the user whose arrival notification request has been received.

Further, in one aspect of the present invention: the arrival notification means determines, based on identification information for identifying whether or not to notify the arrival notification to the user whose arrival notification request has been received, whether or not to notify the arrival notification to the user; the out-of-stock notification system further includes means for setting the identification information so as to avoid carrying out the subsequent arrival notification when the user whose arrival notification request has been received makes an access to the item page of the item during a period from a time point when the arrival notification is notified to a time point when the item becomes out of stock; and the out-of-stock notification means notifies, when, after the arrival notification is notified, the item becomes out of stock in a state in which the identification information represents that the arrival notification is to be notified, the out-of-stock notification to the user whose arrival notification request has been received.

Further, in one aspect of the present invention, the out-of-stock notification system further includes out-of-stock notification determination means for determining whether or not the out-of-stock notification has been presented to the user whose arrival notification request has been received, and the out-of-stock notification means changes, based on a determination result made by the out-of-stock notification determination means, a notification form of the subsequent out-of-stock notification.

Further, in one aspect of the present invention, the out-of-stock notification system further includes arrival notification determination means for determining whether or not the arrival notification has been presented to the user whose arrival notification request has been received, and the out-of-stock notification means changes, based on a determination result made by the arrival notification determination means, a notification form of the subsequent out-of-stock notification.

Further, in one aspect of the present invention, the out-of-stock notification system further includes access determination means for determining whether or not the user whose arrival notification request has been received has made an access to the item page after the out-of-stock notification was notified, and the out-of-stock notification means changes, based on a determination result made by the access determination means, a notification form of the subsequent out-of-stock notification.

Further, in one aspect of the present invention, the out-of-stock notification is notified by using at least one of a plurality of types of notification medium, and the out-of-stock notification means changes the type of the notification medium to be used out of the plurality of types of notification medium, thereby changing the notification form of the out-of-stock notification.

Further, in one aspect of the present invention, the out-of-stock notification is notified by using at least one of a plurality of types of template, and the out-of-stock notification means changes the type of the template to be used out of the plurality of types of notification medium, thereby changing the notification form of the out-of-stock notification.

Further, in one aspect of the present invention, the out-of-stock notification system further includes out-of-stock notification determination means for determining whether or not the out-of-stock notification has been presented to the user whose arrival notification request has been received, and the arrival notification means changes, based on a determination result made by the out-of-stock notification determination means, a notification form of the subsequent arrival notification.

Further, in one aspect of the present invention, the out-of-stock notification system further includes arrival notification determination means for determining whether or not the arrival notification has been presented to the user whose arrival notification request has been received, and the arrival notification means changes, based on a determination result made by the arrival notification determination means, a notification form of the subsequent arrival notification.

Further, in one aspect of the present invention, the out-of-stock notification system further includes access determination means for determining whether or not the user whose arrival notification request has been received has made an access to the item page after the out-of-stock notification was notified, and the arrival notification means changes, based on the determination result made by the access determination means, a notification form of the subsequent arrival notification.

Further, in one aspect of the present invention, the arrival notification is notified by using at least one of a plurality of types of notification medium, and the arrival notification means changes the type of the notification medium to be used out of the plurality of types of notification medium, thereby changing the notification form of the arrival notification.

Further, in one aspect of the present invention, the arrival notification is notified by using at least one of a plurality of types of template, and the arrival notification means changes the type of the template to be used out of the plurality of types of notification medium, thereby changing the notification form of the arrival notification.

Further, in one aspect of the present invention: the out-of-stock notification is an electronic mail to be transmitted to the user whose arrival notification request has been received;

the out-of-stock notification system further includes means for acquiring time point information on a time point when the electronic mail is opened by the user whose arrival notification request has been received; and the out-of-stock notification means determines, based on the time point information, a transmission time point of the out-of-stock notification.

Further, in one aspect of the present invention: the arrival notification is an electronic mail to be transmitted to the user whose arrival notification request has been received; the out-of-stock notification system further includes means for acquiring time point information on a time point when the electronic mail is opened by the user whose arrival notification request has been received; and the arrival notification means determines, based on the time point information, a transmission time point of the arrival notification.

Further, in one aspect of the present invention, the out-of-stock notification system further includes arrival notification determination means for determining whether or not the arrival notification has been presented to the user whose arrival notification request has been received, and the out-of-stock notification means notifies the out-of-stock notification based on a determination result made by the arrival notification determination means.

Further, in one aspect of the present invention, the notification control system further includes means for acquiring a quantity of the items specified by the user whose arrival notification request has been received, and the out-of-stock notification means notifies the out-of-stock notification to the user whose arrival notification request has been received when it is determined that the items are out of stock again based on a current quantity of the items in stock and the quantity specified by the user whose arrival notification request has been received.

### Advantageous Effects of Invention

According to one embodiment of the present invention, it is possible to reduce such a possibility that a user who has requested for an arrival notification makes an access to an item page of an item which is out of stock.

### BRIEF DESCRIPTION OF DRAWINGS

FIG. 1 is a diagram illustrating an example of the overall configuration of an online shopping system according to embodiment of the present invention.

FIG. 2 is a hardware configuration diagram of a sales management server.

FIG. 3 is a hardware configuration diagram of a user terminal.

FIG. 4 is a diagram illustrating a screen example of an item page.

FIG. 5 is a diagram illustrating a screen example of an item page that is displayed when an item is out of stock.

FIG. 6 is a diagram illustrating an example of an arrival notification mail.

FIG. 7 is a diagram illustrating an example of an out-of-stock notification mail.

FIG. 8 is a functional block diagram illustrating an example of functional blocks that are realized in the online shopping system.

FIG. 9 is a table showing a data storage example of stock data.

FIG. 10 is a table showing a data storage example of user data.

FIG. 11 is a table showing a data storage example of arrival notification data.

FIG. 12 is a diagram illustrating processing that is executed in the online shopping system.

FIG. 13 is a diagram illustrating processing that is executed in the online shopping system.

FIG. 14 is a functional block diagram of a modification example of the present invention.

FIG. 15 is a diagram illustrating a case where an out-of-stock notification is displayed on a screen.

FIG. 16 is a table showing usage states of respective media.

FIG. 17 is a table showing usage states of respective templates.

FIG. 18 is a diagram illustrating an overview of processing in a modification example (4) of the present invention.

### DESCRIPTION OF EMBODIMENTS

### 1. Hardware Configuration of Online Shopping System

An exemplary embodiment of the present invention is described in detail below with reference to the drawings. Note that, described here is a case of applying an out-of-stock notification system according to the present invention to an online shopping system that uses the Internet to sell merchandise.

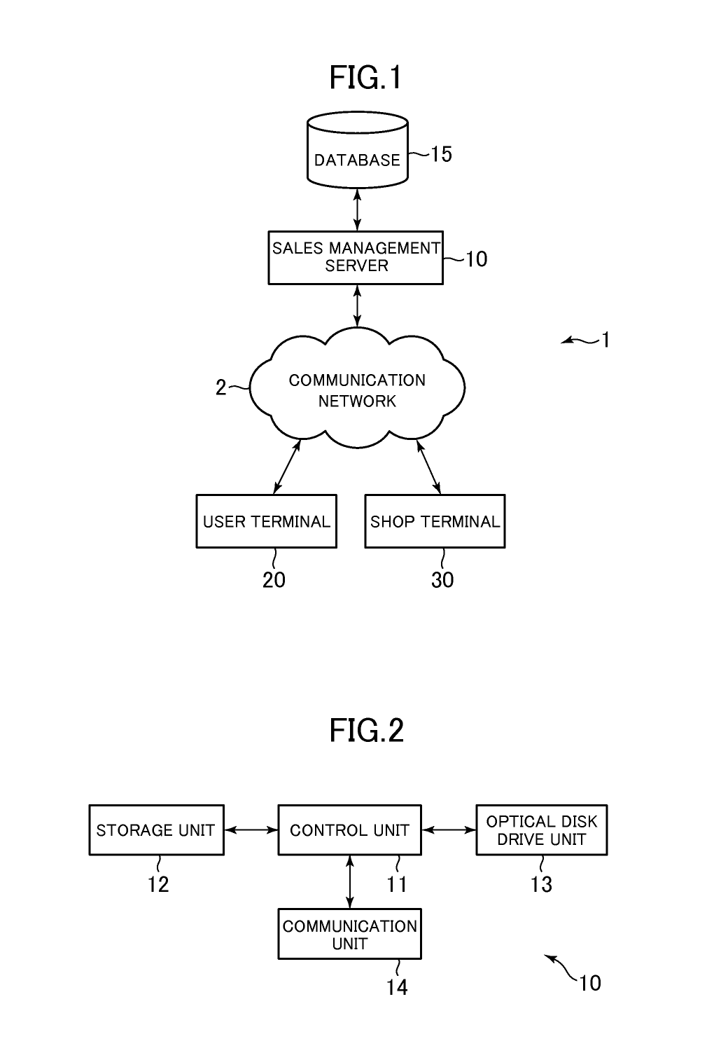

FIG. 1 is a diagram illustrating an example of the overall configuration of an online shopping system according to the embodiment of the present invention. As illustrated in FIG. 1, the online shopping system which is denoted by 1 includes a sales management server 10 (an out-of-stock notification device), a database 15, a user terminal 20, and a shop terminal 30. The sales management server 10 is connected to the user terminal 20 and the shop terminal 30 via a communication network 2 so that data can be transmitted/received to/from the user terminal 20 and the shop terminal 30.

FIG. 2 is a hardware configuration diagram of the sales management server 10. The sales management server 10 is, for example, a server computer. As illustrated in FIG. 2, the sales management server 10 includes a control unit 11, a storage unit 12, an optical disc drive unit 13, and a communication unit 14.

The control unit 11 includes, for example, one or a plurality of microprocessors. The control unit 11 executes processing in accordance with an operating system or program stored in the storage unit 12.

The storage unit 12 includes a main memory and auxiliary storage. For example, the main memory is a RAM, and the auxiliary storage is a hard disk drive, a solid state drive, or the like.

The optical disc drive unit 13 reads a program and data recorded on an optical disc (information recording medium). The program and data recorded on the optical disc are supplied to the storage unit 12 via the optical disc drive unit 13. In other words, the program and data recorded on the optical disc are read by the optical disc drive unit 13, and are stored in the storage unit 12.

Note that, the sales management server 10 may be configured to include a component for reading a program and data stored in an information recording medium (for example, memory card) other than an optical disc so that the program and data are supplied to the storage unit 12 via the information recording medium other than the optical disc.

The communication unit 14 includes a network card. The communication unit 14 executes data communication over the communication network 2. The program and data may be supplied to the storage unit 12 over the communication network 2.

The sales management server 10 can make an access to the database 15. The database 15 may be built on the sales management server 10 or on a server separate from the sales management server 10.

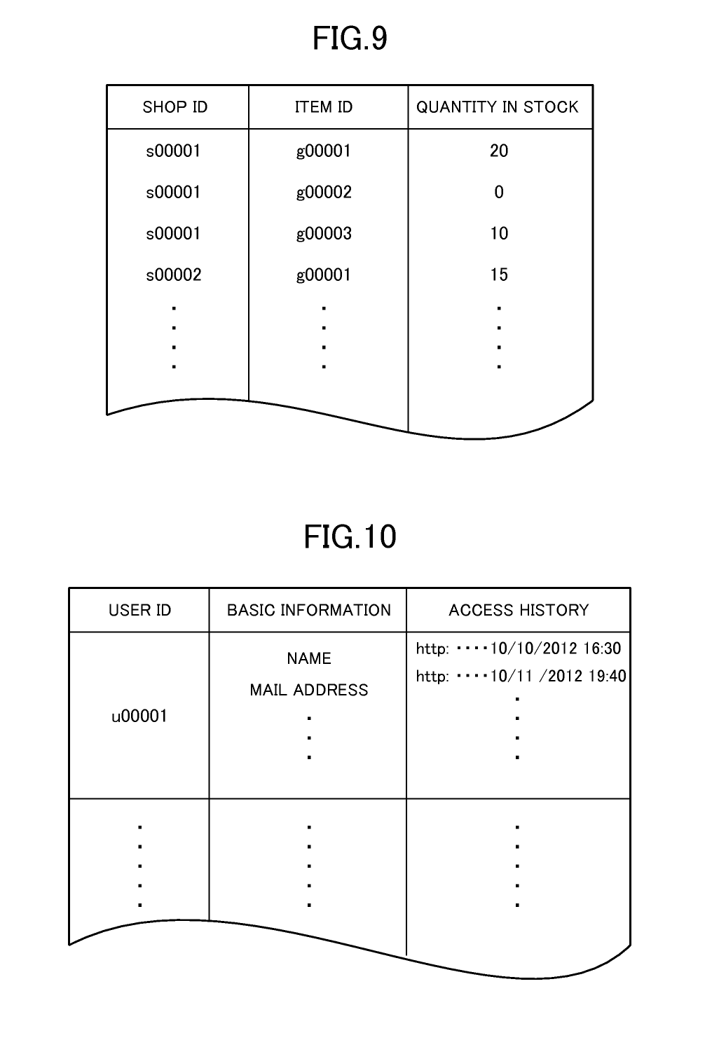

The database 15 stores various types of information necessary to provide merchandise to users. The information stored in the database 15 is described later (see FIGS. 9 to 11).

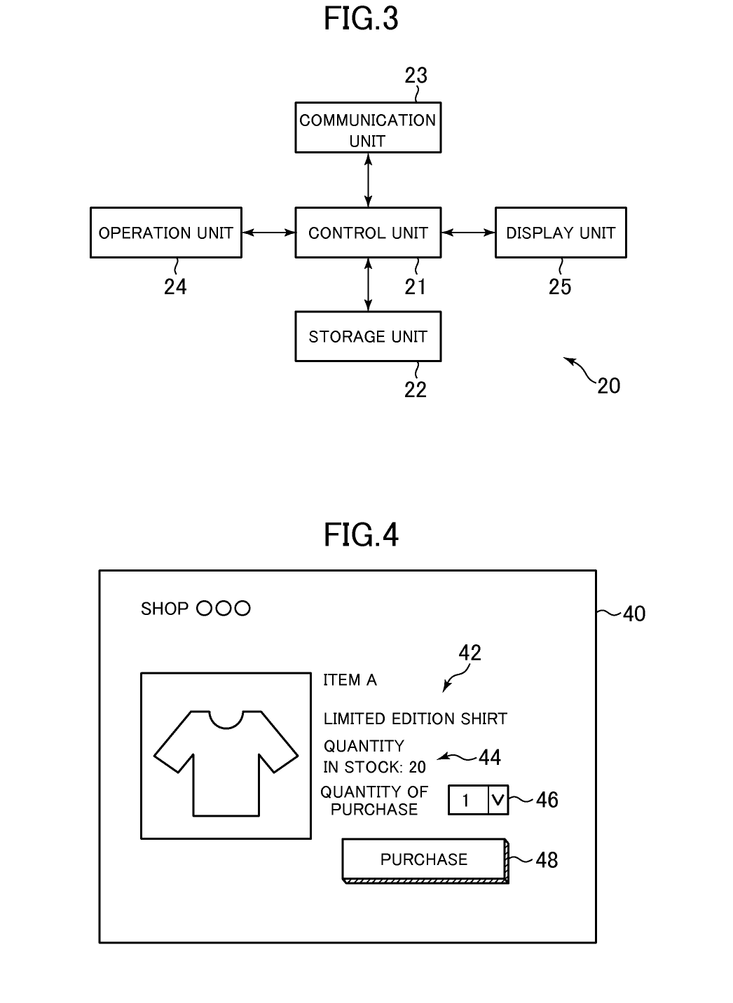

FIG. 3 is a hardware configuration diagram of the user terminal 20. The user terminal 20 is a computer operatedby a user, for example, a cellular phone (including smartphones), a portable information terminal (including tablet computers), or a personal computer. As illustrated in FIG. 3, the user terminal 20 includes a control unit 21, a storage unit 22, a communication unit 23, an operation unit 24, and a display unit 25 . The hardware configurations of the control unit 21, the storage unit 22, and the communication unit 23 are substantially the same as those of the control unit 11, the storage unit 12, and the communication unit 14, and descriptions thereof are therefore omitted.

The operation unit 24 is for the user to operate . The operation unit 24 is, for example, a mouse, a keyboard, or a touch panel. The operation unit 24 transmits the specifics of an operation made by the user to the control unit 21.

The display unit 25 is, for example, a liquid crystal display unit or an organic EL display unit. The display unit 25 displays a screen following an instruction of the control unit 21.

The shop terminal 30 is an information processing device that is set up in a shop. The detailed configuration of the shop terminal 30 is omitted here in order to simplify the description. The shop terminal 30 is, for example, a known personal computer with which the stock quantity of an item can be updated. The shop terminal 30 is operated by a staff member of the shop. Data about the specifics of the operation is transmitted to the sales management server 10 over the communication network 2.

### 2. Flow Up to Item Purchasing by the User

The flow up to the purchasing of an item by the user is described next with reference to a screen displayed on the display unit 25. In this embodiment, an item page for purchasing an item is displayed on the display unit 25 when the user operates the user terminal 20 to make an access to the sales management server 10.

FIG. 4 is a diagram illustrating a screen example of an item page. As illustrated in FIG. 4, an item page 40 displays basic information 42, which is about an item dealt in a shop, an stock quantity 44, which indicates the current stock quantity of the item, an input form 46, in which the user enters the purchase quantity of the item, and a purchase button 48, which is used by the user to purchase the item.

In the screen example of FIG. 4, the item is still in stock as indicated by the stock quantity 44, and the user can purchase the item. For example, when the user enters the purchase quantity of the item in the input form 46 and selects the purchase button 48, the screen shifts to a page for entering a shipping address, a payment method, and the like, thereby completing the operation for purchasing the item.

After the operation for purchasing the item is finished, the database 15 is updated so as to reflect the specifics of the purchase. For instance, the database 15 is updated so that the stock quantity 44 of the item decreases by the quantity of the item purchased by the user. Note that, information indicating the specifics of a purchase made by the user is transmitted from the sales management server 10 to the shop terminal 30, and a staff member of the shop ships the item.

As described above, the user can purchase the item on the item page 40 when the item is still in stock whereas the user cannot purchase the item on the item page 40 in the case where the item has gone out of stock.

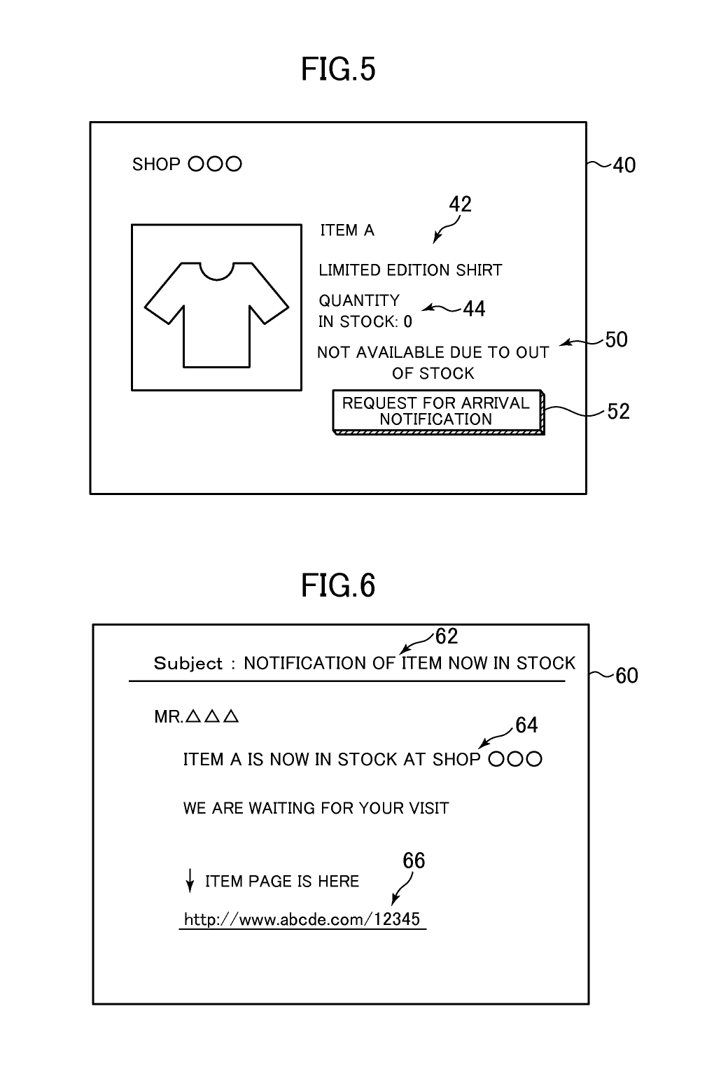

FIG. 5 is a diagram illustrating a screen example of the item page 40 that is displayed when an item is out of stock. As illustrated in FIG. 5, a message 50 to the effect that the item is out of stock and cannot be purchased is displayed. Here, the input form 46 and the purchase button 48 are removed from the item page 40 so that the user cannot order the item.

The item page 40 also displays an arrival notification request button 52 as illustrated in FIG. 5. In the case where the user selects the arrival notification request button 52, the user is notified of the arrival of the out-of-stock item when the item arrives. Here, a case where an electronic mail is transmitted to the user is described as an example of the arrival notification. An electronic mail transmitted as an arrival notification is hereinafter simply referred to as arrival notification mail.

FIG. 6 is a diagram illustrating an example of the arrival notification mail. As illustrated in FIG. 6, the arrival notification mail which is denoted by 60 includes a subject 62 and a message 64 which indicate that the item has arrived, and a link 66 to the item page 40. When the user opens the arrival notification mail 60 and selects the link 66, the display unit 25 displays the item page 40. In the case where the item is still in stock at the time the user makes an access to the item page 40, for example, the item page 40 as the one illustrated in FIG. 4 is displayed and the user can purchase the item.

On the other hand, if the item which came in stock has been sold immediately, when the user selects the link 66, and makes an access to the item page 40, the item is possibly out of stock again. In this case, the user cannot purchase the item. Therefore, in this embodiment, when the item corresponding to the arrival notification request is out of stock again, an out-of-stock notification is transmitted. A description is given of a case where an electronic mail is transmitted to the user as an example of the out-of-stock notification in the same way as in the arrival notification. An electronic mail transmitted as the out-of-stock notification is hereinafter simply referred to as out-of-stock notification mail 70.

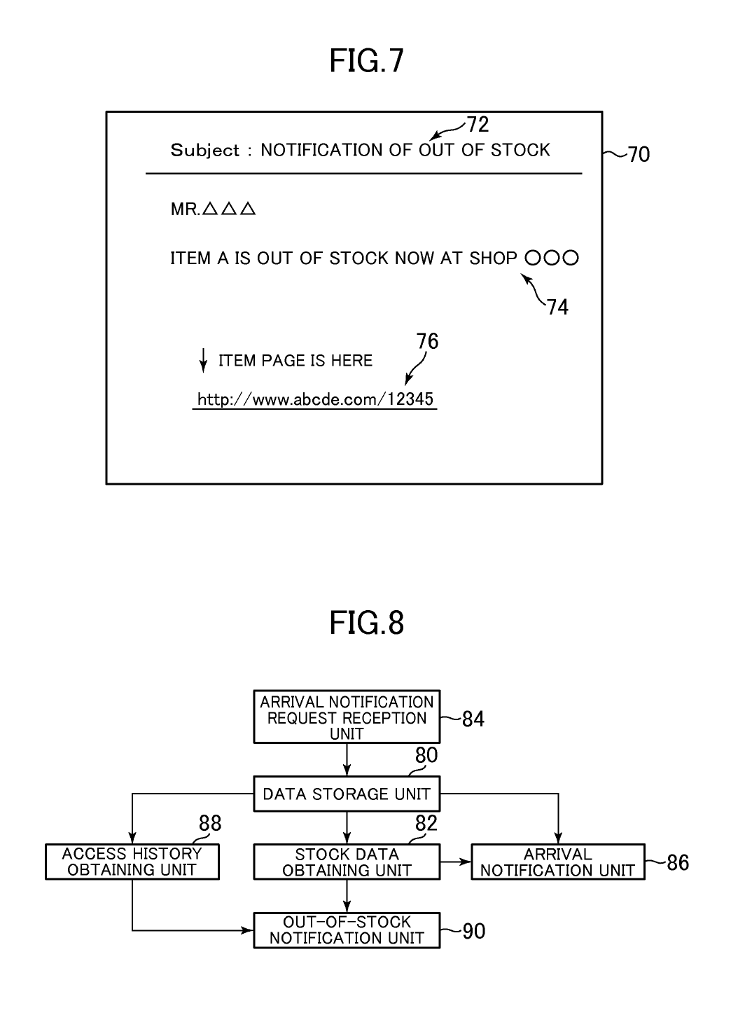

FIG. 7 is a diagram illustrating an example of the out-of-stock notification mail 70. As illustrated in FIG. 7, the out-of-stock notification mail 70 includes a subject 72 and a message 74 which indicate that the item has gone out of stock again, and a link 76 to the item page 40. As described above, in this embodiment, when the item becomes out of stock again after the arrival notification mail 60 has been transmitted, the out-of-stock notification mail 70 is transmitted to the user, thereby reducing such a possibility that the user makes an access to the page of the item which is out of stock again. A detailed description is now given of this technology.

### 3. Functions Realized in the Online Shopping System

FIG. 8 is a functional block diagram illustrating an example of functional blocks that are realized in the online shopping system 1. As illustrated in FIG. 8, the functions include a data storage unit 80, a stock data obtaining unit 82, an arrival notification request reception unit 84, an arrival notification unit 86, an access history obtaining unit 88, and an out-of-stock notification unit 90. Of these functions, the data storage unit 80 is realized mainly by the database 15, and the rest are realized mainly by the control unit 11.

### 3-1. Data Storage Unit

The data storage unit 80 stores various types of data necessary to sell merchandise. The description given here takes as an example a case where the data storage unit 80 stores stock data, which is about the stock of an item, user data, which is about each user who uses the online shopping system 1, and arrival notification data, which is for identifying a user who has requested for an arrival notification.

[Stock Data]

FIG. 9 is a table showing a data storage example of the stock data. In the stock data, a shop ID for identifying a shop, an item ID for identifying an item that is dealt in by the shop, and the stock quantity of the item are stored in association with one another as shown in FIG. 9. The stock data is updated in response to a user's purchase operation or the operation of the shop's staff member.

For example, the stock data is updated depending on the utilization state of the shop. The definition of the utilization state here includes the utilization state of a shop in the online shopping system 1 and the utilization state of the shop in the real world (for example, the state of the purchase of the item by customers who actually visit the shop). In other words, what is stored as the stock data is updated when, for example, the item sells at the virtual shop for online shopping and when the item sells in the shop of the real world.

The stock data is also updated in relation to the item arrival state. For example, when an item arrives at a shop, what is stored as the stock data is updated based on the specifics of an operation performed by the shop's staff member. Here, the shop's staff member inputs the quantity of the item that has arrived, and the stock quantity increases by the input quantity of arriving pieces in a record of the stock data that holds the shop ID of the shop and the item ID of the item.

[User Data]

FIG. 10 is a table showing a data storage example of the user data. In the user data, a user ID for identifying a user, basic information about the user (for example, the name, contact information, and a shipping address), and an access history about the history of access by the user to the item page 40 (for example, a URL of an item page 40 accessed by the user and an access date/time) are stored in association with one another as shown in FIG. 10.

A new record is generated in the user data when, for example, a user signs up for the use of the online shopping system 1. A user ID assigned to the signed up user and basic information input by the user are stored in the generated record. Once the sign up is complete, the user can purchase an item on the item page 40. Every time the user makes an access to the item page 40, the access history of the user is updated.

[Arrival Notification Data]

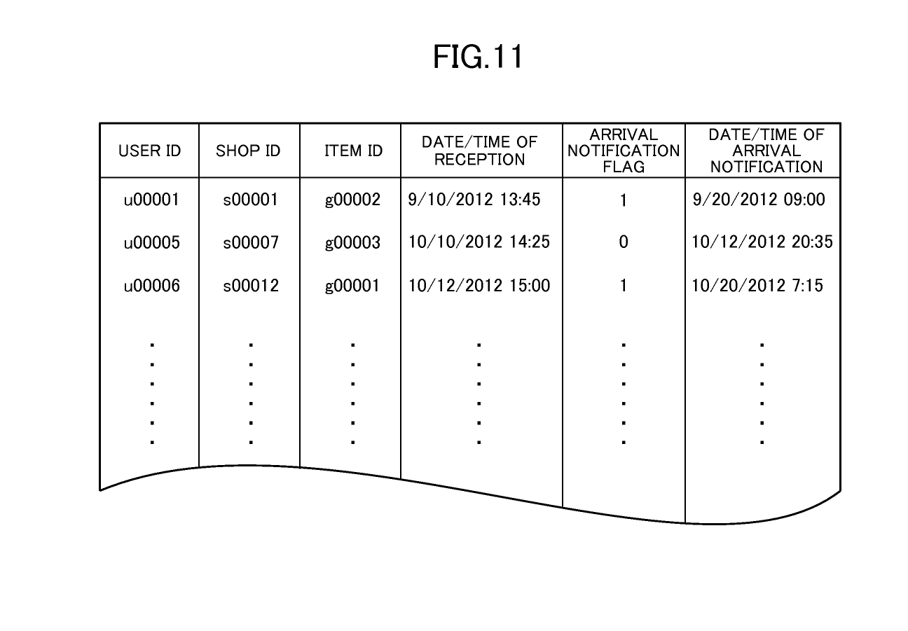

FIG. 11 is a table showing a data storage example of the arrival notification data. In the arrival notification data, a user ID, a shop ID, an item ID, an arrival notification request reception date/time, an arrival notification flag, and an arrival notification date/time are stored as shown in FIG. 11. In this embodiment, a user whose user ID is stored in the arrival notification data is a user who has made an arrival notification request.

For example, when the user selects the arrival notification request button 52 on the item page 40, a new record is generated in the arrival notification data. The user ID of the user who selects the arrival notification request button 52, the shop ID of the shop which deals in the item corresponding to the item page 40, the item ID of the item, and the current date/time are stored in the record in association with one another. Note that, an initial value (“1” in this example) is stored in the arrival notification flag. Further, the arrival notification mail 60 is not transmitted at this time point, and data is thus not stored in the arrival notification date/time.

The arrival notification flag is identification information for identifying whether to notify the user of the arrival. Here, a value “1” of the arrival notification flag (a first value) indicates that, for example, the user has not been notified of the arrival yet and is to receive the arrival notification, and a value “0” of the arrival notification flag (a second value) indicates that, for example, the user has already been notified of the arrival and is not to receive the arrival notification. The value of the arrival notification flag may remain as “1” when the arrival notification mail 60 is transmitted, or maybe updated from “1” to “0” (in other words, identification information is set so as not to notify the arrival notification again).

In this embodiment, the value of the arrival notification date/time is updated in association with a user to whom the arrival notification mail has been transmitted by the arrival notification unit 86, which is described later. For example, the current date/time when the arrival notification unit 86 transmits the arrival notification mail is stored as the arrival notification date/time. In other words, when a time is stored in the arrival notification date/time, the arrival notification has already been notified.

Data stored in the data storage unit 80 is not limited to the example given above. The data storage unit 80 can store various types of data necessary for users to purchase merchandise. For example, the data storage unit 80 may store data on contents (such as templates of the arrival notification mail 60 and the out-of-stock notification mail 70) of the arrival notification and the out-of-stock notification. Additionally, for example, the data storage unit 80 may store data representing basic information about an item (such as a category, images, a price, and a delivery fee) or data about each item page 40 (such as a URL, images, and a layout).

### 3-2. Stock Data Obtaining Unit

The stock data obtaining unit 82 obtains what is stored in means for storing data about the stock of merchandise (for example, the data storage unit 80). The stock data obtaining unit 82 in this embodiment obtains, for each item, the stock quantity of the item which is stored in the stock data.

### 3-3. Arrival Notification Request Reception Unit

The arrival notification request reception unit 84 receives a request for an item arrival notification which is made by a user. Here, performing a given operation (for example, selecting the arrival notification request button 52) on a user's unit corresponds to the user's making an arrival notification request.

The arrival notification request reception unit 84 receives an arrival notification request when, for example, a user selects a given indicator that is included in the item page 40 (for example, the arrival notification request button 52). In other words, the arrival notification request reception unit 84 receives an arrival notification request by being notified of the fact that a user has selected the arrival notification request button 52.

### 3-4. Arrival Notification Unit

The arrival notification unit 86 notifies an arrival of an item to a user whose arrival notification request has been received (namely, a user who has requested for an arrival notification) when the item arrives. Here, transmitting a message or displaying an image corresponds to notifying the arrival. Specifically, the arrival notification unit 86 notifies the arrival by transmitting a message that informs of the arrival of the item (for example, the arrival notification mail 60) or by displaying on the display unit 25 an image indicating the arrival of the item. Note that, the same is true for the out-of-stock notification described later.

The arrival notification unit 86 determines whether to notify a user whose arrival notification request has been received of the arrival, based on identification information for identifying whether or not the user is to be notified of the arrival (for example, the arrival notification flag). In the case where an item that has been out of stock arrives, for example, the arrival notification unit 86 refers to the arrival notification data to identify users who have requested for an arrival notification of the item. The arrival notification unit 86 transmits the arrival notification mail 60 to those who have “1” as the arrival notification flag out of the identified users, and does not transmit the arrival notification mail 60 to those who have “0” as the arrival notification flag out of the identified users. Further, the arrival notification unit 86 transmits the arrival notification mail 60 to the user and stores the current date/time as transmission date/time.

### 3-5. Access History Obtaining Unit

The access history obtaining unit 88 obtains history of access to the item page 40 for the item by the user whose arrival notification request has been received. In this embodiment, the access history obtaining unit 88 obtains the access history of each of the users stored in the user data.

### 3-6. Out-of-Stock Notification Unit

The out-of-stock notification unit 90 notifies, when the item becomes out of stock after the arrival notification has been notified, an out-of-stock notification to the user whose arrival notification request has been received. Here, the time point after the arrival notification is notified is a time point after the transmission date/time of the arrival notification mail 60.

For example, the out-of-stock notification unit 90 determines whether or not the quantity in stock represented by the stock data is equal to or more than a reference quantity (such as 1), thereby determining whether or not the item is out of stock. The state in which the quantity of the items in stock is equal to or more than the reference quantity corresponds to the state in which the item is in stock, and the state in which the quantity of the items in stock is less than the reference quantity corresponds to the state in which the item is out of stock. In other words, a change from the state in which the quantity of the items in stock is equal to or more than the reference quantity to the state in which the quantity in stock is less than the reference quantity corresponds to such a change that the item becomes out of stock.

According to this embodiment, the out-of-stock notification unit 90 notifies the out-of-stock notification if history of access by the user to the item page 40 does not exist in the access history during a period from the time point when the arrival notification is notified to the time point when the item becomes out of stock. For example, the out-of-stock notification unit 90 determines, based on the access history, whether or not the item has become out of stock after the arrival notification was notified and before the user makes an access to the item page 40 of the item. The time point before the user makes an access to the item page 40 is a time point before the access to the item page 40 is received, and, for example, a time point before the item page 40 is displayed on the display unit 25. The out-of-stock notification unit 90 determines whether or not the item has become out of stock again before the user has made an access to the item page 40 after the arrival notification was notified.

For example, when it is determined that the item has become out of stock again after the arrival notification and before the access based on the access history, the out-of-stock notification unit 90 notifies the out-of-stock notification. On the other hand, when it is not determined that the item has become out of stock after the arrival notification and before the access, the out-of-stock notification unit 90 does not notify the out-of-stock notification.

Note that, in this embodiment, the determination processing is notified by the out-of-stock notification unit 90 regardless of whether or not the user actually opens the arrival notification mail 60. The out-of-stock notification unit 90 notifies the out-of-stock notification to a user for which the arrival notification has already been notified. In other words, it can also be said that the out-of-stock notification unit 90 controls whether or not to notify the out-of-stock notification.

Moreover, when the out-of-stock notification is notified for the user, the user ID of the user, the shop ID of a shop and the item ID of an item corresponding to the out-of-stock notification, and a date/time when the out-of-stock notification is notified may be stored in the data storage unit 80 in association with one another. In other words, the history of the out-of-stock notification may be left in the data storage unit 80.

Further, in this embodiment, a description is given of such a configuration that the out-of-stock notification unit 90 determines whether or not an item is out of stock. However, the processing itself of determining whether or not the item is out of stock may be notified by a unit other than the out-of-stock notification unit 90, for example, another system. In this case, for example, the system determines whether or not the item is out of stock, and the out-of-stock notification unit 90 obtains the determination result. In other words, the out-of-stock notification unit 90 transmits the out-of-stock notification mail 70 based on the obtained determination result.

### 4. Processing Notified in Embodiment

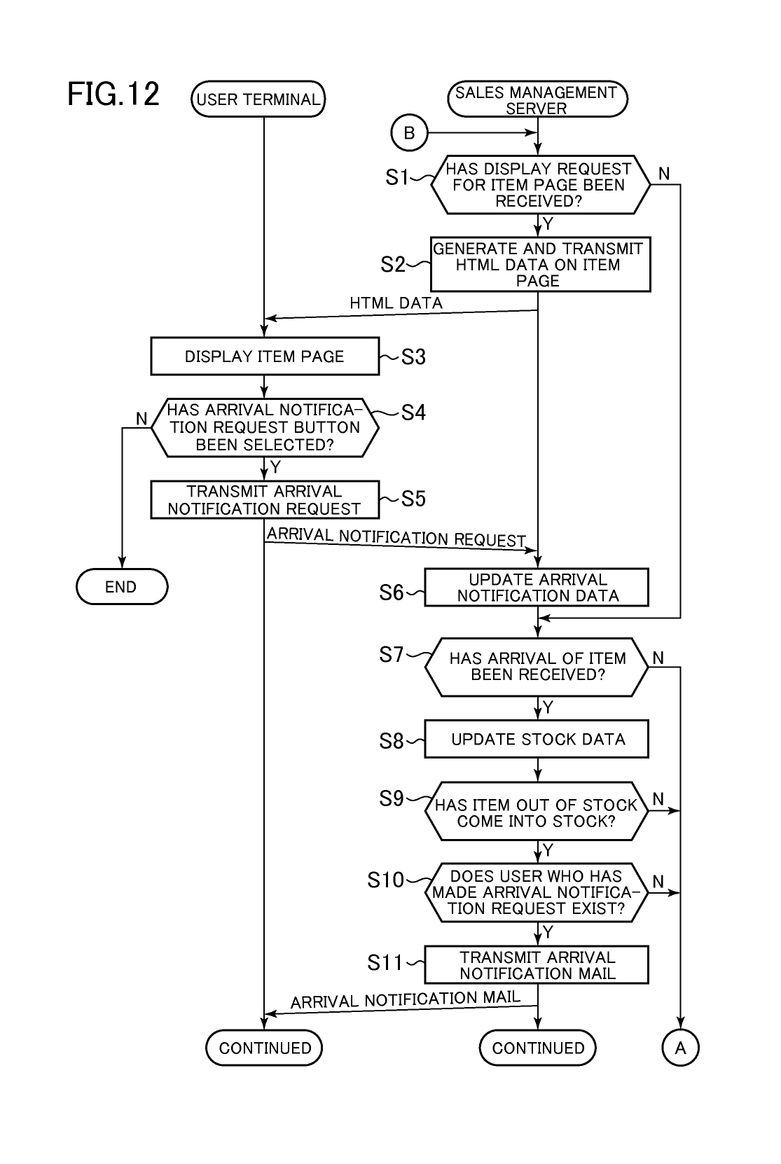

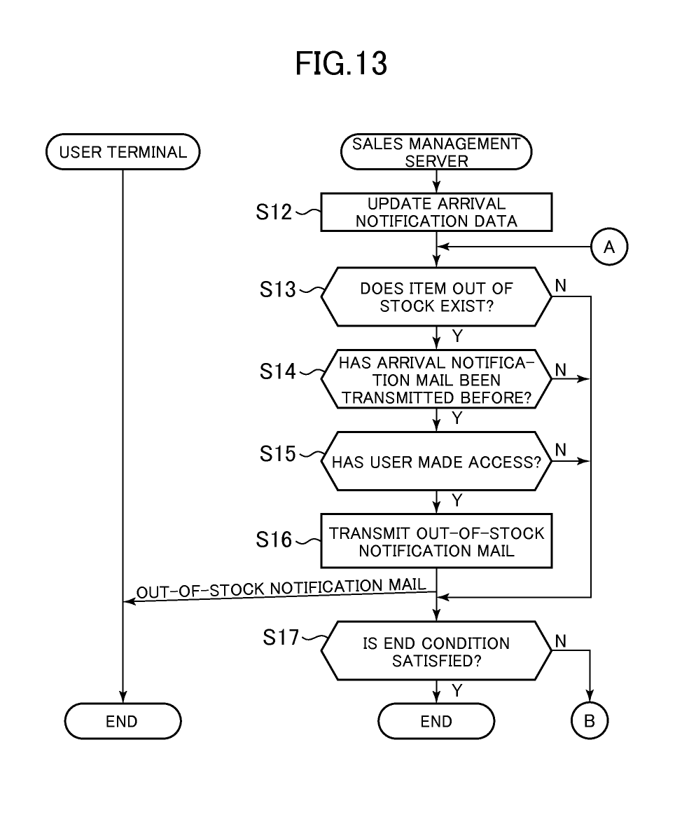

FIGS. 12 and 13 are diagrams illustrating processing notified by the online shopping system 1. The control unit 11 of the sales management server 10 operates based on programs stored in the storage unit 12, the control unit 21 of the user terminal 20 operates based on programs stored in the storage unit 22, thereby carrying out the processing illustrated in FIGS. 12 and 13 to realize the respective functional blocks. Note that, in order to simplify the description, it is assumed that when the processing is notified, a session between the sales management server 10 and the user terminal 20 has been established, and further the user has completed a predetermined login operation.

As illustrated in FIG. 12, first, the control unit 11 in the sales management server 10 determines whether or not the display request for the item page 40 has been received from the user (S1). When information is transmitted from the user terminal 20 to the sales management server 10, an IP address, a user ID, and the like are transmitted. As a result, the sales management server 10 can identify which user makes the access to the item page 40.

When it is determined that the display request for the item page 40 has not been received (S1: N), the sales management server 10 proceeds to processing in S7. On the other hand, when it is determined that the display request for the item page 40 has been received (S1: Y), the control unit 11 generates HTML data on the item page 40, and transmits the HTML data to the user terminal 20 operated by the user who has notified the display request (S2). Note that, in S2, when an item displayed on the item page 40 is in stock, the control unit 11 determines whether or not the user who has notified the display request has notified the arrival notification request for the item. Then, when the user has notified the arrival notification request, the control unit 11 changes the arrival notification flag of the user to “0”. In other words, when the user makes an access to the item page 40 while the item is in stock, the control unit 11 updates the value of the arrival notification flag so as not to subsequently transmit the arrival notification mail 60.

The user terminal 20 receives the HTML data and the control unit 21 displays the item page 40 on the display unit 25 (S3). When the item is in stock, the item page 40 illustrated in FIG. 4 is displayed in S3. Subsequently, purchase processing for the item is notified depending on an operation by the user, and the stock data is appropriately updated. The purchase processing is publicly known processing, and a description thereof is therefore omitted. On the other hand, when the item is out of stock, the item page 40 illustrated in FIG. 5 is displayed in S3, and the user cannot purchase the item.

The control unit 21 determines whether or not the arrival notification request button 52 is selected (S4). When it is determined that the arrival notification request button 52 is selected (S4: Y), the control unit 21 transmits to the sales management server 10 a notification for informing that the arrival notification request button 52 is selected (namely, an arrival notification request) (S5).

The sales management server 10 receives the notification informing that the arrival notification request button 52 is selected (namely, an arrival notification request), and the control unit 11 updates the arrival notification data (S6). In S6, the control unit 11 creates a new record in the arrival notification data to store in the record the user ID of the user who has selected the arrival notification request button 52, the shop ID of the shop corresponding to the item page 40, the item ID of the item corresponding to the item page 40, the current date/time, and the initial value of the arrival notification flag. Note that, as described above, unless the arrival notification mail 60 is transmitted, the data is not stored in the arrival notification date/time.

The control unit 11 determines whether or not information of the arrival of an item has been received from the shop terminal 30 (S7). For example, when a staff member of a shop operates the shop terminal 30 to input the quantity of an item that has arrived, data that includes the shop ID of the shop, the item ID of the item, and the input item piece quantity is transmitted to the sales management server 10. The control unit 11 determines in S7 whether or not this data has been received.

When it is determined that information of the arrival of an item has been received (S7: Y), the control unit 11 updates the stock data based on the received information (S8). In S8, the control unit 11 updates the stock quantity in one of the records of the stock data that holds the shop ID and the item ID that are indicated by the data received from the shop terminal 30.

The control unit 11 determines whether or not the item that has just arrived has been out of stock based on the reception result in S7 (S9). In S9, the control unit 11 determines whether or not the stock quantity has been less than a reference quantity (for example, 1).

When it is determined that the item that has just arrived has been out of stock (S9: Y), the control unit 11 refers to the arrival notification data to determine whether or not there is a user who has requested for an arrival notification of the item that has just arrived (S10). In S10, the control unit 11 determines whether or not a record that stores the shop ID of the shop at which the item has arrived and the item ID of this item is included among records of the arrival notification data.

When it is determined that a user who has requested for the arrival notification exists (S10: Y), the control unit 11 transmits the arrival notification mail 60 to the user (S11). The control unit 11 generates the arrival notification mail 60 regarding the item that has just arrived in S11, and transmits the arrival notification mail 60 to the user having the user ID stored in the arrival notification data.

In FIG. 13, the control unit 11 refers to the arrival notification data, and updates the arrival notification data (S12). In S12, the control unit 11 stores the current date/time in a record storing the user ID, the shop ID, and the item ID corresponding to the arrival notification mail 60. The control unit 11 updates a transmission time of the arrival notification mail 60.

The control unit 11 refers to the stock data, and determines whether or not an item out of stock exists (S13). In S13, the control unit 11 refers to the stock data, and determines whether or not there is an item which has changed from a state in which the quantity in stock is equal to or more than the reference quantity to a state in which the quantity in stock is less than the reference quantity (for example, an item whose quantity in stock has been changed from being equal to or more than 1 to 0).

When it determined that an item out of stock exists (S13: Y), the control unit 11 refers to the arrival notification data, and determines whether or not the arrival notification mail 60 for the item has been previously transmitted (S14). In S14, the control unit 11 refers to the arrival notification data, and determines whether or not there is a record storing the shop ID of a shop dealing in the item out of stock, and the item ID of the item.

When it is determined that the arrival notification mail 60 has previously been transmitted (S14: Y), the control unit 11 determines whether or not the user has made an access to the item page 40 for the item after the arrival notification mail 60 has been transmitted (S15). In S15, the control unit 11 refers to the arrival notification data, and identifies a date/time when the arrival notification mail 60 for the item out of stock has been transmitted. Then, the control unit 11 refers to the access history of the user data, and determines whether or not the user has made an access to the item page 40 after the identified transmission date/time.

When it is determined that the user has not made an access to the item page 40 (S15: Y), the control unit 11 transmits the out-of-stock notification mail 70 to the user (S16). In S16, the control unit 11 generates the out-of-stock notification mail 70 corresponding to the item out of stock at the shop, and transmits the out-of-stock notification mail 70 to the user having the user ID with which the shop ID of the shop and the item ID of the item are associated.

The control unit 11 determines whether or not an end condition is satisfied (S17). The end condition only needs to be a condition determined in advance for finishing the processing. For example, the condition may be whether or not a predetermined time point is reached, whether or not the sales management server 10 is to be restarted, or the like.

When it is determined that the end condition is satisfied (S17: Y), the processing is finished. When it is determined that the end condition is not satisfied (S17: N), the processing returns to S1.

The online shopping system 1 according to the embodiment can transmit the out-of-stock notification mail 70 to the user, thereby reducing such a possibility that the user makes an access to the item page 40 of an item out of stock. Further, when the user who has requested for the arrival notification has made an access to the item page 40 before the item becomes out of stock again, the user may have already purchased the item. Therefore, in this case, the out-of-stock notification mail 70 is not transmitted, so that the unnecessary notification can be prevented from being transmitted to the user.

### 5. Modification Examples

Note that, the present invention is not limited to the embodiment described above, and can be modified suitably without departing from the spirit of the present invention.

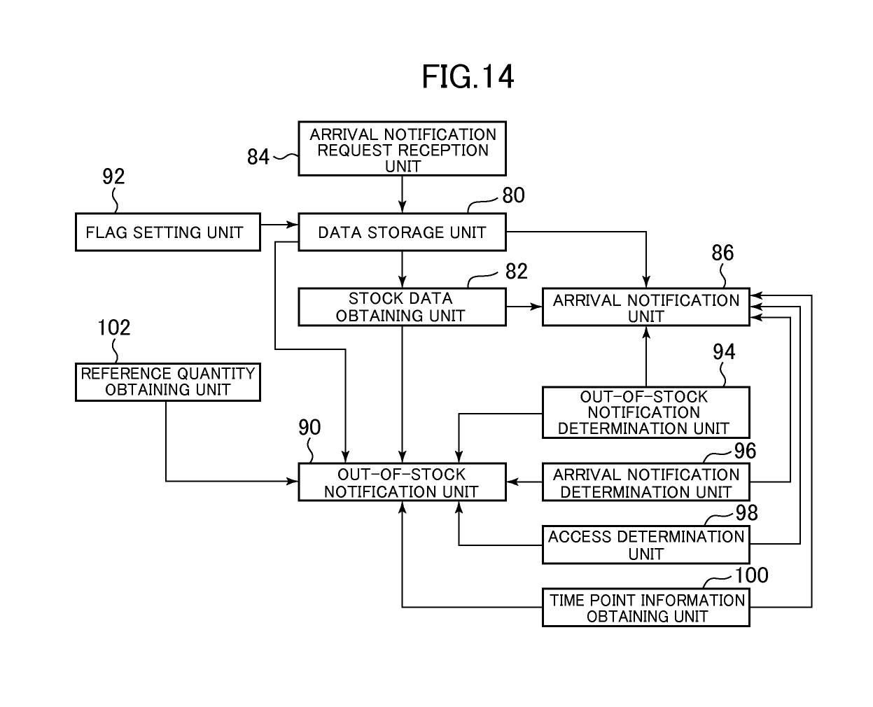

FIG. 14 is a functional block diagram of modification examples according to the present invention. As illustrated in FIG. 14, a flag setting unit 92, an out-of-stock notification determination unit 94, an arrival notification determination unit 96, an access determination unit 98, a time point information obtaining unit 100, and a reference quantity obtaining unit 102 are realized in modification examples described below in addition to the functions of the embodiment described above. These functions are realized mainly by the control unit 11.

(1) For example, in this embodiment, a description is given of the case where the out-of-stock notification unit 90 determines whether or not to transmit the out-of-stock notification mail 70 based on the access history, but whether or not to transmit the out-of-stock notification mail 70 may be controlled by means of another method. For example, whether or not to transmit the out-of-stock notification mail 70 may be determined by estimating whether or not each user has made an access to the item page 40 before the item becomes out of stock based on the value of the arrival notification flag of the user.

The sales management server 10 according to the modification examples includes the flag setting unit 92. When the user whose arrival notification request has been received has made an access to the item page of an item after the arrival notification was notified and until the item becomes out of stock, the flag setting unit 92 sets identification information (such as the arrival notification flag) so that the subsequent arrival notification is not notified. On this occasion, setting the arrival notification flag to “0” corresponds to setting the identification information for avoiding the arrival notification. In other words, when the user has made an access to the item page 40 during the period after the arrival notification mail 60 was transmitted until the item becomes out of stock, the flag setting unit 92 changes the value of the arrival notification flag corresponding to the user to “0”, thereby providing the control so that the arrival notification mail 60 is not subsequently transmitted. This is because when the user has made an access to the item page 40 in the state in which the item is in stock, the user highly possibly immediately purchases the item, and it is highly possible that the arrival notification mail 60 becomes unnecessary.

When, after the arrival notification is notified, the item becomes out of stock in a state in which the identification information (such as the arrival notification flag) represents that the arrival notification is to be notified, the out-of-stock notification unit 90 notifies the out-of-stock notification to the user whose arrival notification request has been received. On this occasion, the out-of-stock notification unit 90 determines whether or not the item is out of stock in the state in which the identification information (such as the arrival notification flag) represents that the arrival notification is to be notified after the arrival notification is notified. For example, the out-of-stock notification unit 90 transmits the out-of-stock notification mail 70 when the item becomes out of stock in the state in which the arrival notification flag is “1”. On the other hand, the out-of-stock notification unit 90 does not transmit the out-of-stock notification mail 70 when the item becomes out of stock in the state in which the arrival notification flag is “0”. In other words, the out-of-stock notification unit 90 refers not to the access history but to the value of the arrival notification flag, thereby estimating whether or not the user has made an access to the item page 40.

According to a first modification example of the present invention, the arrival notification flag can be used to estimate whether or not the user has made an access to the item page 40, thereby determining whether or not to transmit the out-of-stock notification mail 70.

(2) Moreover, for example, a method other than the electronic mail maybe used for the out-of-stock notification, or the template of the out-of-stock notification mail 70 may be changed, thereby making the out-of-stock notification more remarkable to the user.

(2-1) For example, when the user has not opened the out-of-stock notification mail 70, the method of carrying out the out-of-stock notification to the user may be changed.

The sales management server 10 according to this modification example includes the out-of-stock notification determination unit 94. The out-of-stock notification determination unit 94 determines whether or not the out-of-stock notification has been presented to the user. The out-of-stock notification determination unit 94 determines whether or not a past out-of-stock notification (in other words, an out-of-stock notification which has already been notified to the user, for example, an out-of-stock notification notified in a past predetermined period) has been presented to the user. The out-of-stock notification subject to the determination may be the most recent out-of-stock notification, or the most recent out-of-stock notification and an out-of-stock notification notified earlier than that.

Moreover, the phrase “the out-of-stock notification is presented to the user” means that the out-of-stock notification is displayed on the display unit 25 corresponding to the user, for example, the out-of-stock notification mail 70 is opened. On this occasion, the method of determining whether or not the out-of-stock notification has been presented to the user depends on a notification medium (channel) used as the out-of-stock notification.

When the electronic mail is used as the out-of-stock notification, the out-of-stock notification determination unit 94 determines whether or not the user has opened the out-of-stock notification mail 70. For example, if the out-of-stock notification mail 70 is an electronic mail of the HTML format including image tags, when the user opens the out-of-stock notification mail 70, a read request for an image is transmitted to the sales management server 10. The out-of-stock notification determination unit 94 determines whether or not the read request has been received from the user terminal 20, thereby determining whether or not the user has opened the out-of-stock notification mail 70.

Note that, in this case, a predetermined parameter is inserted into the image tag, and the sales management server 10 obtains the parameter when receiving the read request so that the sales management server 10 can identify which user has made the read request for the image (in other words, has opened the out-of-stock notification mail 70). Further, the method of determining whether or not the electronic mail is opened is not limited to this method, and publicly known various methods are applicable. For example, an open confirmation function of a mailer software program may be used to determine whether or not the out-of-stock notification mail 70 is opened.

Moreover, when an image or a string displayed on a screen (web browser) is used as the out-of-stock notification, the out-of-stock notification determination unit 94 refers to the access history in the user data, thereby determining whether or not the user has browsed the screen.

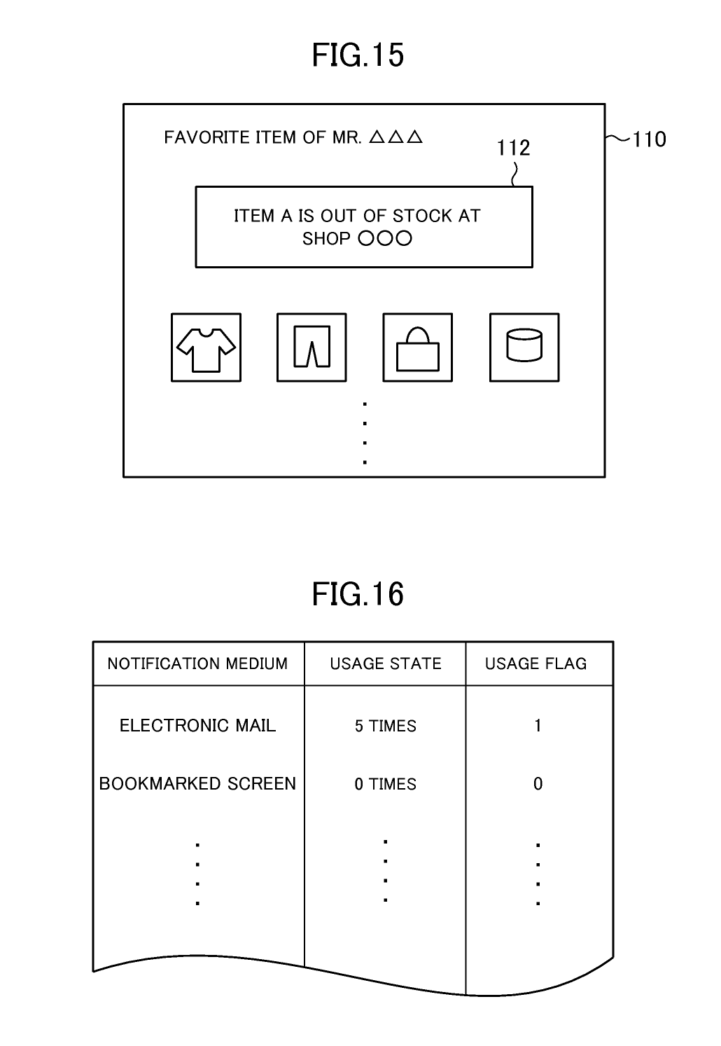

FIG. 15 is a diagram illustrating a case where the out-of-stock notification is displayed on the screen. As illustrated in FIG. 15, for example, a message 112 representing an out-of-stock state of the item for which the arrival notification request has been made is displayed on a bookmarked screen 110 displaying the item page 40 bookmarked by each user. When the user browses the bookmarked screen 110, the out-of-stock notification determination unit 94 determines that the out-of-stock notification is presented.

Note that, the screen displaying the out-of-stock notification only needs to be, for example, a screen displayed on the browser, and other than that, for example, at least one of a web page representing the item page 40 which has been browsed by each user, a top page corresponding to the online shopping system 1, and a toolbar of the web browser may be used.

Moreover, data representing the determination result made by the out-of-stock notification determination unit 94 may be stored in the user data. For example, when the history of the out-of-stock notification is recorded in the data storage unit 80, information representing whether or not the out-of-stock notification has been presented to the user may also be stored. When it is determined that the past out-of-stock notification has been presented to the user, the information is updated.

The out-of-stock notification unit 90 according to this modification example changes a notification form (notification method) of the subsequent out-of-stock notifications based on the determination result made by the out-of-stock notification determination unit 94. The subsequent out-of-stock notification is an out-of-stock notification to be notified to the user in the future. The notification form is a type of notification medium used as the out-of-stock notification, or a content of a sentence included in the out-of-stock notification.

[Case of Changing Notification Medium]

First, a description is given of a case where the type of the notification medium used as the out-of-stock notification is changed, thereby changing the notification form. For example, when the out-of-stock notification is notified by using at least one of a plurality of types of notification medium, the out-of-stock notification unit 90 changes the type of notification medium to be used out of the plurality of types of notification medium, thereby changing the notification form of the out-of-stock notification.

FIG. 16 is a table illustrating usage states of respective notification media. Data representing the usage states is stored in the data storage unit 80, and is stored, for example, in a record corresponding to each user of the user data. As illustrated in FIG. 16, the usage state (for example, usage frequency) of each of the plurality of types of the notification medium and a usage flag are stored in association with each other. When each of the notification media is used as the out-of-stock notification, the usage state is updated.

The usage flag is a flag representing a notification medium currently used as the out-of-stock notification. For example, a usage flag value of “0” represents that the medium is not being used as the out-of-stock notification, and a usage flag value of “1” represents that the medium is being used as the out-of-stock notification.

The out-of-stock notification unit 90 changes the type of the notification medium used for the out-of-stock notification when the past out-of-stock notification has not been presented to the user. In this modification example, changing the usage flag value corresponds to changing the type of notification medium. Further, changing the type of the notification medium herein means that the change includes both changing the number of types of notification medium (in other words, adding or deleting the notification medium used for the out-of-stock notification), and changing the type used for the out-of-stock notification without changing the number of types of the notification medium.

For example, the out-of-stock notification unit 90 changes the type of the notification medium so that a notification medium which is not currently used is used to notify the out-of-stock notification. In other words, the out-of-stock notification unit 90 changes the usage flag value of the notification medium from “0” to “1”. After that, the out-of-stock notification unit 90 uses the type of notification medium having the changed value to notify the out-of-stock notification.

Moreover, for example, the out-of-stock notification unit 90 does not change the type of the notification medium used for the out-of-stock notification when the past out-of-stock notification has been presented to the user. In other words, the out-of-stock notification unit 90 does not change the usage flag value of the notification medium. In this case, the user highly possibly notices the out-of-stock notification, and the out-of-stock notification unit 90 uses the notification medium of the same type as the notification medium used for the previous out-of-stock notification to notify the out-of-stock notification.

[Case of Changing Template]

Next, a description is given of a case where the template of the out-of-stock notification is changed, thereby changing the notification form. The template herein is the string included in the out-of-stock notification and is, for example, a fixed phrase (format) of a message or a subject. For example, when the out-of-stock notification is notified by using at least one of a plurality of types of template, the out-of-stock notification unit 90 changes the type of the template to be used out of the plurality of types of template, thereby changing the notification form of the out-of-stock notification.

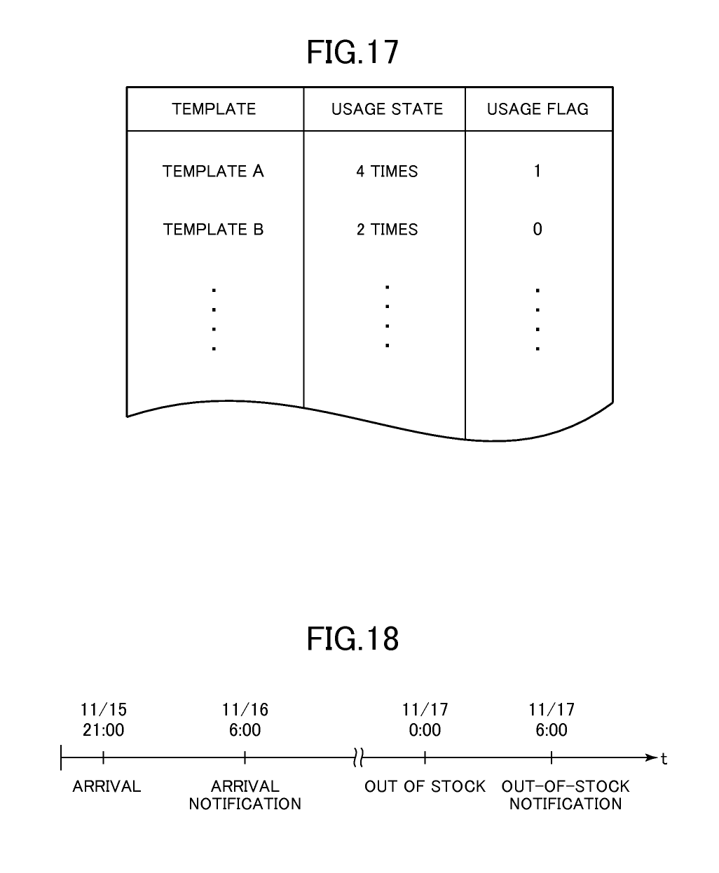

FIG. 17 is a table illustrating usage states of respective templates. Data representing the usage states is stored in the data storage unit 80, and is stored, for example, in a record corresponding to each user of the user data. As illustrated in FIG. 17, the usage state (for example, usage frequency) of each of the plurality of types of the template and a usage flag and are stored in association with each other.

The usage flag is a flag representing a template currently used as the out-of-stock notification. For example, a usage flag value of “0” represents that the template is not being used as the out-of-stock notification, and a usage flag value of “1” represents that the template is being used as the out-of-stock notification.

The out-of-stock notification unit 90 changes the type of the template used for the out-of-stock notification when the past out-of-stock notification has not been presented to the user. In this modification example, changing the usage flag value corresponds to changing the type of the template.

For example, the out-of-stock notification unit 90 changes the type of the template so that a template which is not currently used is used to notify the out-of-stock notification. In other words, the out-of-stock notification unit 90 changes the usage flag value of the template from “0” to “1” and sets usage flag values of other templates to “0”. After that, the out-of-stock notification unit 90 uses the type of the template having the changed value to notify the out-of-stock notification.

Moreover, for example, the out-of-stock notification unit 90 does not change the type of the template used for the out-of-stock notification when the past out-of-stock notification has been presented to the user. In other words, the out-of-stock notification unit 90 does not change the usage flag value of the template. In this case, the user highly possibly notices the out-of-stock notification, and the out-of-stock notification unit 90 uses the template of the same type as the template used for the previous out-of-stock notification to notify the out-of-stock notification.

According to the modification example (2-1), for example, the notification form of the out-of-stock notification can be changed depending on whether or not the user has opened the out-of-stock notification mail 70, and the out-of-stock notification can be notified in the notification form easily recognized by each user.

Note that, the out-of-stock notification unit 90 only needs to change at least one of the notification medium and the template, and may change both of the notification medium and the template by combining the forms described above. In other words, the out-of-stock notification unit 90 may change both the notification medium and the template used as the out-of-stock notification based on the determination result made by the out-of-stock notification determination unit 94. The same holds true for modification examples relating to the processing of changing the notification form out of modification examples described later.

(2-2) Moreover, for example, the form of the out-of-stock notification may be changed depending on whether or not the arrival notification mail 60 has been opened.

The sales management server 10 according to this modification example includes an arrival notification determination unit 96. The arrival notification determination unit 96 determines whether or not the arrival notification has been presented to the user. As a method of determining whether or not the arrival notification has been presented is the same as the method of determining whether or not the out-of-stock notification has been presented, and the wording “out-of-stock notification” in the description of the out-of-stock notification determination unit 94 in the modification example (2-1) may be interpreted as “arrival notification”.

In other words, the arrival notification determination unit 96 determines whether or not the arrival notification mail 60 has been opened, or whether or not the user has browsed a screen including the arrival notification. Further, similarly to the modification example (2-1), information representing whether or not the arrival notification has been presented to the user may be stored in the user data, and the information is updated based on the determination result made by the arrival notification determination unit 96.

The arrival notification determination unit 96 may determine whether or not the arrival notification has been presented before the out-of-stock notification mail 70 is transmitted, or may determine whether or not the arrival notification has been presented after the out-of-stock notification mail 70 was transmitted.

The out-of-stock notification unit 90 changes the notification form of the subsequent out-of-stock notifications based on the determination result made by the arrival notification determination unit 96. The method itself of changing the notification form of the out-of-stock notification is the same as that in the modification example (2-1), and at least one of the notification medium and the template is changed.

For example, when it is determined that the past arrival notification has been presented to the user, the out-of-stock notification unit 90 changes the notification form of the out-of-stock notification. In this case, the user notices the arrival notification mail 60 and thinks that the item is in stock, and hence the out-of-stock notification can be made more remarkable so as not to disappoint the user. In other words, when it is determined that the past arrival notification has not been presented to the user, the out-of-stock notification unit 90 does not change the notification form of the out-of-stock notification.

On the other hand, when it is determined that the past arrival notification has not been presented to the user, the out-of-stock notification unit 90 may change the notification form of the out-of-stock notification. In this case, the user does not notice the arrival notification mail 60, and thus may not notice the out-of-stock notification mail 70 which is the electronic mail as the arrival notification mail 60. Therefore, the notification form of the out-of-stock notification can be changed so as to be more remarkable. In other words, when it is determined that the past arrival notification has been presented to the user, the out-of-stock notification unit 90 does not change the notification form of the out-of-stock notification.

According to the modification example (2-2), for example, the notification form of the out-of-stock notification can be changed depending on whether or not the user has opened the arrival notification mail 60, and the out-of-stock notification can be notified in the notification form easily noticed by each user.

(2-3) Moreover, for example, the notification form of the subsequent out-of-stock notification mails 70 may be changed depending on whether or not the user has made an access to the item page 40 after the out-of-stock notification mail 70 is transmitted.

The sales management server 10 according to this modification example includes an access determination unit 98. The access determination unit 98 determines whether or not the user has made an access to the item page 40 after the out-of-stock notification is notified. For example, the access determination unit 98 refers to the access history in the user data, thereby determining whether or not the user has made an access to the item page 40 of the item for which the arrival notification request has been made after the out-of-stock notification is notified.

The out-of-stock notification unit 90 changes the notification form of the subsequent out-of-stock notifications based on the determination result made by the access determination unit 98. The method of changing the notification form of the out-of-stock notification is the same as that in the modification example (2-1), and at least one of the notification medium and the template is changed.

For example, when the access determination unit 98 determines that the user has made an access to the item page 40, the out-of-stock notification unit 90 changes the notification form of the out-of-stock notification. In this case, the user may have made an access to the item page 40 of the item out of stock and may have been disappointed, and hence the notification form of the out-of-stock notification can be changed so as to be remarkable.

In other words, when the access determination unit 98 determines that the user has not made an access to the item page 40, the out-of-stock notification unit 90 does not change the notification form of the out-of-stock notification.

On the other hand, for example, when the access determination unit 98 determines that the user has not made an access to the item page 40, the out-of-stock notification unit 90 may change the notification form of the out-of-stock notification. In this case, the user may have not noticed the out-of-stock notification, and may have not made an access to the item page 40, and hence the notification form of the subsequent out-of-stock notifications can be changed so as to be remarkable. In other words, when the access determination unit 98 determines that the user has made an access to the item page 40, the out-of-stock notification unit 90 does not change the notification form of the out-of-stock notification.

According to the modification example (2-3), for example, the notification form of the subsequent out-of-stock notification mails 70 can be changed depending on whether or not the user has made an access to the item page 40 after the out-of-stock notification mail 70 is transmitted, and the out-of-stock notification can be notified in the notification form easily noticed by each user.

Note that, the modification examples (2-1) to (2-3) may be combined. In other words, the out-of-stock notification unit 90 may change the notification form of the out-of-stock notification based on any two or all of the determination result made by the out-of-stock notification determination unit 94, the determination result made by the arrival notification determination unit 96, and the determination result made by the access determination unit 98. For example, when the user has opened none of the arrival notification mail 60 and the out-of-stock notification mail 70, and has not made an access to the item page 40, the user may be no longer interested in the item itself, and may have intentionally avoided opening the notifications. Thus, the notification form of the out-of-stock notification may not be changed.

(3) Moreover, for example, as for the out-of-stock notification, a method other than the electronic mail may be used or the template may be changed for the arrival notification, thereby making the arrival notification remarkable to a user.

(3-1) For example, the form of the arrival notification may be changed depending on whether or not the user has opened the out-of-stock notification mail 70.

The sales management server 10 according to this modification example includes the out-of-stock notification determination unit 94. The determination method by the out-of-stock notification determination unit 94 is the same as that in the modification example (2-1), and a description thereof is therefore omitted.

The arrival notification unit 86 according to this modification example changes the notification form of the subsequent arrival notifications based on the determination result made by the out-of-stock notification determination unit 94. The method itself of changing the notification form of the arrival notification is the same as the method of changing the notification form of the out-of-stock notification described in the modification example (2-1). The “out-of-stock notification” in the modification example (2-1) only needs to be interpreted as the “arrival notification”.

In other words, when the arrival notification is notified by using at least one of a plurality of types of notification medium, the arrival notification unit 86 changes the type of the notification medium to be used out of the plurality of types of notification medium, thereby changing the notification form of the arrival notification. Moreover, for example, when the arrival notification is notified by using at least one of a plurality of types of template, the arrival notification unit 86 changes the type of the template to be used out of the plurality of types of notification medium, thereby changing the notification form of the arrival notification.

For example, when it is determined that the past out-of-stock notification has not been presented to the user, the arrival notification unit 86 changes the notification form of the arrival notification. In this case, the user may not notice that the item is out of stock, and may be disappointed when the user makes an access to the item page 40, and subsequent arrival notifications can thus be remarkable so that the user will make an access to the item page 40 earlier. In other words, when it is determined that the past out-of-stock notification has been presented to the user, the out-of-stock notification unit 90 does not change the notification form of the arrival notification.

On the other hand, when it is determined that the past out-of-stock notification has been presented to the user, the arrival notification unit 86 may change the notification form of the arrival notification. In this case, the user may have seen the arrival notification mail 60, and may be disappointed, and arrival notifications can subsequently be noticed earlier by the user. In other words, when it is determined that the past out-of-stock notification has not been presented to the user, the out-of-stock notification unit 90 does not change the notification form of the arrival notification.

According to the modification example (3-1), for example, the notification form of the arrival notification can be changed depending on whether or not the user has opened the out-of-stock notification mail 70.

Note that, the arrival notification unit 86 only needs to change at least one of the notification medium and the template of the arrival notification, and such a point that the arrival notification unit 86 may change only one of the notification medium and the template, or both thereof is the same as in the modification example (2-1).

(3-2) For example, the form of the arrival notification may be changed depending on whether or not the user has opened the arrival notification mail 60.

The sales management server 10 according to this modification example includes the arrival notification determination unit 96. The determination method by the arrival notification determination unit 96 is the same as that in the modification example (2-2), and a description thereof is therefore omitted.

The arrival notification unit 86 changes the notification form of the subsequent arrival notifications based on the determination result made by the arrival notification determination unit 96.

For example, when it is determined that the past arrival notification has not been presented to the user, the arrival notification unit 86 changes the notification form of the arrival notification. In this case, the user may not notice the arrival notification mail 60, and out-of-stock notifications can thus be remarkable. In other words, when it is determined that the past arrival notification has been presented to the user, the arrival notification unit 86 does not change the notification form of the arrival notification.

On the other hand, when it is determined that the past arrival notification has not been presented to the user, the arrival notification unit 86 may not change the notification form of the arrival notification. In this case, the user may have lost interest in the item, and may have intentionally avoided opening the arrival notification mail 60. Thus, the arrival notification may not be changed.

According to the modification example (3-2), for example, the notification form of the arrival notification can be changed depending on whether or not the user has opened the arrival notification mail 60.

(3-3) Moreover, for example, the notification form of the subsequent arrival notifications may be changed depending on whether or not the user has made an access to the item page 40.

The sales management server 10 according to this modification example includes the access determination unit 98. The determination method by the access determination unit 98 is the same as that in the modification example (2-3), and a description thereof is therefore omitted.

The arrival notification unit 86 changes the notification form of the subsequent arrival notifications based on the determination result made by the access determination unit 98.

For example, when the access determination unit 98 determines that the user has made an access to the item page 40, the arrival notification unit 86 changes the notification form of the arrival notification. In this case, the user may have made an access to the itempage 40 of the item out of stock, andmay have been disappointed, and the subsequent arrival notifications can thus be remarkable so that the user will make an access to the item page 40 earlier. In other words, when the access determination unit 98 determines that the user has not made an access to the item page 40, the arrival notification unit 86 does not change the notification form of the arrival notification.

On the other hand, for example, when the access determination unit 98 determines that the user has not made an access to the item page 40, the arrival notification unit 86 may change the notification form of the arrival notification. In this case, the user may have not noticed the arrival notification, and may thus have not made an access to the item page 40, and the notification form of the subsequent arrival notifications can be changed so as to be remarkable. In other words, when the access determination unit 98 determines that the user has made an access to the item page 40, the arrival notification unit 86 may not change the notification form of the arrival notification.

According to the modification example (3-3), for example, the notification form of the subsequent arrival notifications can be changed depending on whether or not the user has made an access to the item page 40 after the transmission of the out-of-stock notification mail 70.

Note that, the modification examples (3-1) to (3-3) may be combined. In other words, the out-of-stock notification unit 90 may change the notification form of the arrival notification based on any two or all of the determination result made by the out-of-stock notification determination unit 94, the determination result made by the arrival notification determination unit 96, and the determination result made by the access determination unit 98. For example, when the user has opened none of the arrival notification mail 60 and the out-of-stock notification mail 70, and has not made an access to the item page 40, the user may be no longer interested in the item itself, and may have intentionally avoided opening the notifications. Thus, the notification form of the out-of-stock notification may not be changed.

Further, the modification examples (2-1) to (2-3) and the modification examples (3-1) to (3-3) may be combined with one another. In other words, the notification forms of both of the arrival notification and the out-of-stock notification maybe changed based on at least one of the determination result made by the out-of-stock notification determination unit 94, the determination result made by the arrival notification determination unit 96, and the determination result made by the access determination unit 98.

(4) Moreover, for example, a time point of opening an electronic mail by the user may be analyzed, thereby transmitting the arrival notification mail 60 and the out-of-stock notification mail 70 in a time zone in which the user can easily open the electronic mail.

FIG. 18 is a chart illustrating an overview of processing in the modification example (4). On this occasion, for example, the time zone in which the user can easily open the electronic mail is estimated based on past open states of the electronic mails by the user. An example illustrated in FIG. 18 represents a case in which the user tends to open the electronic mails at seven in the morning. For example, when an item which is out of stock has come into stock, the transmission of the arrival notification mail 60 may be waited until a predetermined time point in the time zone, and when the item becomes out of stock again, the transmission of the out-of-stock notification mail 70 may be waited until the predetermined time point in the time zone.

The sales management server 10 according to this modification example includes a time point information obtaining unit 100. The time point information obtaining unit 100 obtains time point information on the time point of opening the electronic mail by the user. A method of determining whether or not the electronic mail has been opened is the same as the method described for the cases of the out-of-stock notification determination unit 94 and the arrival notification determination unit 96.

The time point information obtaining unit 100 obtains a date/time when a past electronic mail (such as the arrival notification mail 60, the out-of-stock notification mail 70, and other electronic mails such as direct mails) transmitted by the sales management server 10 to the user was opened. For example, the time point information obtaining unit 100 records current date/time if it is determined that the electronic mail has been opened in the data storage unit 80, and estimates the time zone in which the user opens the electronic mails based on the recorded contents. In this case, the time point information obtaining unit 100 estimates the time zone in which the user opens the electronic mails by assigning the times and dates of opening past electronic mails to a given equation.

(4-1) For example, when the out-of-stock notification is an electronic mail to be transmitted to the user, the out-of-stock notification unit 90 determines a transmission time point of the out-of-stock notification based on the time point information. The out-of-stock notification unit 90 transmits the out-of-stock notification mail 70 in a period determined based on the estimated opening date/time. For example, the out-of-stock notification unit 90 transmits the out-of-stock notification mail 70 at the estimated opening date/time, or a predetermined time before or after the estimated opening date/time. In other words, the out-of-stock notification unit 90 postpones the transmission of the out-of-stock notification mail 70.

According to the modification example (4-1), the out-of-stock notification mail 70 is transmitted in the time zone in which the user can easily open the electronic mails, and the out-of-stock notification mail 70 can thus be remarkable to the user.

(4-2) Moreover, for example, when the arrival notification is an electronic mail to be transmitted to the user, the arrival notification unit 86 determines a transmission time point of the arrival notification based on the time point information. The arrival notification unit 86 transmits the arrival notification mail 60 in a period determinedbased on the estimated opening date/time. For example, the arrival notification unit 86 transmits the arrival notification mail 60 at the estimated opening date/time, or a predetermined time before or after the estimated opening date/time. In other words, the arrival notification unit 86 postpones the transmission of the arrival notification mail 60.

According to the modification example (4-2), the arrival notification mail 60 is transmitted in the time zone in which the user can easily open the electronic mails, and the arrival notification mail 60 can thus be remarkable to the user.

(5) Moreover, for example, the opening of the arrival notification mail 60 by the user may be set as a condition for transmitting the out-of-stock notification mail 70.

The sales management server 10 according to this modification example includes the arrival notification determination unit 96. The determination method by the arrival notification determination unit 96 is the same as that in the modification example (2-2), and a description thereof is therefore omitted.

The out-of-stock notification unit 90 notifies the out-of-stock notification based on the determination result made by the arrival notification determination unit 96 and the determination result made by the out-of-stock notification unit 90.

When the arrival notification determination unit 96 determines that the arrival notification has been presented, the out-of-stock notification unit 90 notifies the out-of-stock notification. In this case, the user has seen the arrival notification, and thinks that the item is in stock, and the out-of-stock notification mail 70 can be transmitted soon. In other words, when the arrival notification determination unit 96 determines that the arrival notification is not presented, the out-of-stock notification unit 90 does not notify the out-of-stock notification.

On the other hand, when the arrival notification determination unit 96 determines that the arrival notification is not presented, the out-of-stock notification unit 90 may notify the out-of-stock notification. In this case, the current stock state can be notified by transmitting the out-of-stock notification mail 70 before the user sees the arrival notification. In other words, when the arrival notification determination unit 96 determines that the arrival notification is not presented, the out-of-stock notification unit 90 may not notify the out-of-stock notification.

According to the modification example (5), the opening of the arrival notification mail 60 by the user can be set as the condition for transmitting the out-of-stock notification mail 70.

(6) Moreover, for example, even if one item is left, it is determined that the item is in stock, but for a user who purchases a set of the items may not purchase the items if the quantity of items is not equal to or more than the quantity which the user wants. For example, the user who wants to purchase a set of 20 items may not purchase the items even if the quantity in stock increases from 0 to 10, and may not purchase the items until the quantity in stock becomes 20 or more. Therefore, for example, when the quantity in stock becomes less than 20, the out-of-stock notification mail 70 may be transmitted to the user.

The online shopping system 1 according to the modification example (6) includes a reference quantity obtaining unit 102. The reference quantity obtaining unit 102 obtains a quantity of items (namely, a reference quantity) specified by the user. For example, when the user selects the arrival notification request button 52, the user inputs the quantity of the items. The reference quantity obtaining unit 102 obtains the numerical value input from the operation unit 24 of the user terminal 20 by the user, thereby acquiring the reference quantity specified by the user. The numerical value specified on this occasion is a quantity of items the user wants to purchase, and may be considered as a condition for carrying out the arrival notification or the out-of-stock notification.

The out-of-stock notification unit 90 according to this modification example notifies the out-of-stock notification to the user whose arrival notification request has been received when it is determined that the items are out of stock again based on a current quantity of the items in stock and the quantity specified by the user whose arrival notification request has been received. For example, the out-of-stock notification unit 90 determines whether or not the items are in stock based on the current quantity of the items in stock and the quantity specified by the user. The out-of-stock notification unit 90 determines whether or not the quantity of the items in stock is equal to or more than the quantity specified by the user, and determines whether or not the quantity in stock is equal to or more than the quantity specified by the user who has requested for the arrival notification, thereby determining whether or not the items are in stock.

Note that, on this occasion, a description is given of the case where the out-of-stock determination unit 90 notifies the processing of determining whether or not the item is in stock, but the modification example (6) is the same as the embodiment in such a point that the determination processing may be notified in other functions or other systems, and the determination result made by the determination processing may be obtained by the out-of-stock notification unit 90.

According to the modification example (6), the condition for the out-of-stock notification, which the stock needs to satisfy, can be changed depending on the preference of the user.

(7) Moreover, for example, when a user who has received the arrival notification mail 60 for a certain item has purchased another item which is the same or similar to the item, the out-of-stock notification mail 70 maybe restricted to be transmitted. The another item may be an item dealt in by the same shop as a shop responding to the arrival notification request, or may be an item dealt in by another shop. The similar item is an item that is the same in attribute (nature), and, for example, an item in the same item category.

Moreover, for example, while a case where stock data is updated when a user purchases an item or a staff member of a shop performs an item arrival operation has been described, various known methods are applicable when it comes to the method of updating the stock data. For example, in the case where a user adds items that the user intends to purchase to a list (in other words, shopping cart) before actually purchasing the items, the stock data may be updated at the time an item is added to the list.

Moreover, for example, the user may cancel his/her own arrival notification request. For example, in the case where a user has requested for an arrival notification of an item, the arrival notification request button 52 on the item page 40 of this item is already selected, and the arrival notification request may be cancelled by selecting the button once more. In the case where the arrival notification request is cancelled, out-of-stock notification is not sent to the user.

Moreover, for example, while a case of realizing the functional blocks with a single server computer has been described in the embodiment, the functions may be distributed among a plurality of computers that constitute the online shopping system 1. In the case where the online shopping system 1 includes a plurality of servers, different servers may function as, for example, a server for receiving an arrival notification request (namely, a server that realizes the arrival notification request reception unit 84) and a server that actually transmits the arrival notification mail 60 and the out-of-stock notification mail 70 (namely, a server that realizes the arrival notification unit 86 and the out-of-stock notification unit 90).

Further, some functions of the functional blocks may be realized in the user terminal 20. For example, when the screen of the arrival notification or the out-of-stock notification is displayed by the JavaScript (trademark), the script is executed mainly by the user terminal 20. Accordingly, the user terminal 20 may realize the function of the arrival notification unit 86 and the out-of-stock notification unit 90 by executing the processing of displaying the screen.

Moreover, for example, while the description given above deals with an example of applying an out-of-stock notification system according to the present invention to an online shopping system, the notification control system according to the present invention is applicable to various systems that involve notifying an out-of-stock state. For instance, the out-of-stock notification control system according to the present invention is applicable to a system in which a user orders an item on an item page and picks up the item at a real shop, instead of online shopping.

The invention claimed is:

1. An out-of-stock notification device, comprising:
an obtaining unit that obtains what is stored in a storage that stores data on a stock of an item;
an arrival notification request unit that receives an arrival notification request for the item from a user;
an arrival notification unit that notifies, in a case where the item comes in stock, an arrival notification to the user whose arrival notification request has been received; and
an out-of-stock notification unit that notifies, in a case where the item becomes out of stock after the arrival notification is notified, an out-of-stock notification to the user whose arrival notification request has been received.

2. The out-of-stock notification device according to claim 1, further comprising:
an history obtaining unit that obtains access history to an item page of the item by the user whose arrival notification request has been received,
wherein the out-of-stock notification unit notifies, in a case where such history that the user accesses to the item page is absent in the access history in a period from a time point when the arrival notification is notified to a time point when the item becomes out of stock, the out-of-stock notification to the user whose arrival notification request has been received.

3. The out-of-stock notification device according to claim 1,
wherein the arrival notification unit determines, based on identification information for identifying whether or not to notify the arrival notification to the user whose arrival notification request has been received, whether or not to notify the arrival notification to the user,
wherein the out-of-stock notification device further comprises a setting unit that sets the identification information so as to avoid carrying out the subsequent arrival notification in a case where the user whose arrival notification request has been received accesses the item page of the item during a period from a time point when the arrival notification is notified to a time point when the item becomes out of stock, and
wherein the out-of-stock notification unit notifies, in a case where, after the arrival notification is notified, the item becomes out of stock in a state in which the identification information represents that the arrival notification is to be notified, the out-of-stock notification to the user whose arrival notification request has been received.

4. The out-of-stock notification device according to claim 1, further comprising:
an out-of-stock notification determination unit that determines whether or not the out-of-stock notification has been presented to the user whose arrival notification request has been received,
wherein the out-of-stock notification unit changes, based on a determination result made by the out-of-stock notification determination unit, a notification form of the subsequent out-of-stock notification.

5. The out-of-stock notification device according to claim 1, further comprising:
an arrival notification determination unit that determines whether or not the arrival notification has been presented to the user whose arrival notification request has been received,
wherein the out-of-stock notification unit changes, based on a determination result made by the arrival notification determination unit, a notification form of the subsequent out-of-stock notification.

6. The out-of-stock notification device according to claim 1, further comprising:
an access determination unit that determines whether or not the user whose arrival notification request has been received has accessed the item page after the out-of-stock notification was notified,
wherein the out-of-stock notification unit changes, based on a determination result made by the access determination unit, a notification form of the subsequent out-of-stock notification.

7. The out-of-stock notification device according to claim 4,
wherein the out-of-stock notification unit changes the type of the notification medium to be used out of a plurality of types of notification medium, thereby changing the notification form of the out-of-stock notification.

8. The out-of-stock notification device according to claim 4,
wherein the out-of-stock notification unit changes the type of the template to be used out of a plurality of types of notification medium, thereby changing the notification form of the out-of-stock notification.

9. The out-of-stock notification device according to claim 1, further comprising:
an out-of-stock notification determination unit that determines whether or not the out-of-stock notification has been presented to the user whose arrival notification request has been received,
wherein the arrival notification unit changes, based on a determination result made by the out-of-stock notification determination unit, a notification form of the subsequent arrival notification.

10. The out-of-stock notification device according to claim 1, further comprising:
an arrival notification determination unit that determines whether or not the arrival notification has been presented to the user whose arrival notification request has been received,
wherein the arrival notification unit changes, based on a determination result made by the arrival notification determination unit, a notification form of the subsequent arrival notification.

11. The out-of-stock notification device according to claim 1, further comprising:
an access determination unit that determines whether or not the user whose arrival notification request has been received has accessed the item page after the out-of-stock notification was notified,
wherein the arrival notification unit changes, based on a determination result made by the access determination means, a notification form of the subsequent arrival notification.

12. The out-of-stock notification device according to claim 9,
wherein the arrival notification unit changes the type of the notification medium to be used out of a plurality of types of notification medium, thereby changing the notification form of the arrival notification.

13. The out-of-stock notification device according to claim 9,
wherein the arrival notification unit changes the type of the template to be used out of a plurality of types of notification medium, thereby changing the notification form of the arrival notification.

14. The out-of-stock notification device according to claim 1,
further comprises:
a time point information obtaining unit that obtains time point information on a time point when the electronic mail, which is the arrival notification, is opened by the user whose arrival notification request has been received, and
wherein the out-of-stock notification unit determines, based on the time point information, a transmission time point of the out-of-stock notification.

15. The out-of-stock notification device according to claim 1,
further comprises:
a time point information obtaining unit that obtains time point information on a time point when the electronic mail which is the arrival notification is opened by the user whose arrival notification request has been received, and
wherein the arrival notification unit determines, based on the time point information, a transmission time point of the arrival notification.

16. The out-of-stock notification device according to claim 1, further comprising:
an arrival notification determination unit that determines whether or not the arrival notification has been presented to the user whose arrival notification request has been received,
wherein the out-of-stock notification unit notifies the out-of-stock notification based on a determination result made by the arrival notification determination unit.

17. The out-of-stock notification device according to claim 1, further comprising:
a quantity obtaining unit that obtains a quantity of the items specified by the user whose arrival notification request has been received,
wherein the out-of-stock notification unit notifies the out-of-stock notification to the user whose arrival notification request has been received in a case where it is determined that the items are out of stock again based on a current quantity of the items in stock and the quantity specified by the user whose arrival notification request has been received.

18. (canceled)

19. An out-of-stock notification method, comprising:
obtaining what is stored in a storage that stores data on a stock of an item;
receiving an arrival notification request for the item from a user;
notifying, in a case where the item comes in stock, an arrival notification to the user whose arrival notification request has been received; and
notifying, in a case where the item becomes out of stock after the arrival notification is notified, an out-of-stock notification to the user whose arrival notification request has been received.

20. A non-transitory computer readable information medium Storing a program for causing a computer to perform the function of:
obtaining what is stored in for a storage that stores data on a stock of an item;
receiving an arrival notification request for the item from a user;
notifying, in a case where the item comes in stock, an arrival notification to the user whose arrival notification request has been received; and
notifying, in a case where the item becomes out of stock after the arrival notification is notified, an out-of-stock notification to the user whose arrival notification request has been received.
